(19) United States
(12) Patent Application Publication
(10) Pub. No.: US 2009/0319316 A1
(43) Pub. Date: Dec. 24, 2009

(54) Method and System of Using Structured Social Networks and Communities to Create and Maintain Business Service Models

(76) Inventors: Kurt Westerfeld, Ashburn, VA (US); Adam Cusson, Bristow, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/488,399

(22) Filed: Jun. 19, 2009

Related U.S. Application Data
(60) Provisional application No. 61/079,129, filed on Jul. 8, 2008.
(60) Provisional application No. 61/074,074, filed on Jun. 19, 2008.

(51) Int. Cl. G06Q 10/00; G06Q 50/00

(52) U.S. Cl. 705/7

(57) ABSTRACT

A method is described for distributing the creation and maintenance tasks of a Business Service Model over social networks and communities in enterprise environments. Members of a community are enabled to view all Business Service Models and components in the community, and in accordance with permissions are enabled to read, create, modify, delete, update, tag, mark and comment on Business service Models and components, including being able to add missing relationships, elements, state propagation rules, or algorithms. Community workspaces are provided for tracking creation and maintenance activities, and individual workspaces are provided summarizing these activities taking place within the individual's communities. Combined together in a continually iterative model, these computer implemented mechanisms provide IT organizations with a complete, accurate and current Business Service Model.

### RELATED APPLICATIONS

This application claims priority from U.S. Provisional Patent Application No. 61/079,129 titled “Method of Using Structured Social Networks and Communities to Create and Maintain Business Service Models” filed on Jul. 8, 2008, and from U.S. Provisional Patent Application No. 61/074,074 titled “System and Method for Using a Collaborative Network to Maintain a Configuration Management Database” filed on Jun. 19, 2008.

This application is related to U.S. patent application Ser. No. ______ for “Method And System of Using Social Networks and Communities to Ensure Data Quality of Configuration Items in a Configuration Management Database” and U.S. patent application Ser. No. ______ for “Method And System of Using Social Networks and Communities to Create And Maintain Relationships Between Configuration Items in a Configuration Management Database”, both filed contemporaneously herewith and incorporated by reference herein.

### BACKGROUND OF THE INVENTION

1. Field of the Invention

The present invention relates to information technology (IT) systems and more specifically, to methods and apparatus for building and maintaining accurate Business Service Models for such systems.

2. Background Description

Enterprises rely on large numbers of services in order to perform their regular back office activities (such as Human Resources, Finance, etc.), front office tasks (e.g. accepting orders, handling customer calls), and managing their customer interactions (e.g. deploying new services, online self-service offerings). These services are highly interdependent and complex and inherently difficult to manage because of the varied technologies involved, large numbers of infrastructure elements, environments where frequent changes are made (planned and unplanned), and high expectations (implied and explicit) for availability and performance. Additional challenges are introduced when examining the various parties that can be involved in building, operating, maintaining, and modifying any given service—internal IT staff, project managers, representatives from the business, external service providers, 3^{rd} party vendors for service components, to mention a few.

IT organizations manage large and complex IT environments to provide a plurality of services to their internal and external customers. The large scale of these environments produces a large volume of information that must be tracked in order to manage the environment. This information can include (but is not limited to) performance data, availability statistics, incident reports, real-time alerts/events, change requests, maintenance schedules, and service level objectives. The complexity is further increased when an organization needs to account for the large numbers of relationships that must be captured in order to form a complete Business Service Model. In addition to these, organizations must define rules that govern how the information from each of the components of the Business Service Model can be aggregated to glean insight into characteristics of the business service as a whole.

A typical Business Service Model is made up of an hierarchical structure of elements (both physical and logical) and their key attributes with a number of disparate data sources all being combined to populate details about each element and the overall service. These data sources can include (but are not limited to) asset management systems, performance monitoring systems, trouble ticketing systems, service desk solutions, dependency mapping solutions, and manual user maintained data sources (e.g. spreadsheets, diagrams). This information generally reflects information about the elements themselves and limited information about the relationships between the elements. In most organizations, the information required to complete and correct the Business Service Model resides in widely dispersed documents, scattered diagrams, and in the memory of subject matter experts in the organization.

The end result is that most IT organizations face challenges associated with having no Business Service Models which establish clear, accurate, reliable, and readily available sources of information regarding the components of critical business services. Business Service Models are used to define and represent the state and status of various services that exist within enterprises. Without a complete and accurate Business Service Model, organizations are forced to manage their environments at the element level without accounting for where these elements fit into the larger service model. The challenges that result from this situation include the inability to fully understand the impact and scope of any alerts, infrastructure generated events, proposed changes/maintenance work, or to quickly understand the impact of any operational failures in the environment. The business level impact can include (but is not limited to) slow mean time to repair for a service (which could result in lost revenue, and regulatory challenges) to loss of confidence in the service (customers migrating to competitors). These difficulties are particularly acute in enterprises where the services are complex, the number of parties involved is large, and a myriad of technologies must be integrated into the Business Service Model.

There is a need, therefore, for a methodology for creating and maintaining business service models in such circumstances.

### SUMMARY OF THE INVENTION

In order to overcome the above described problems with creating and maintaining Business Service Models, the present invention organizes and distributes the work among those within the organization closest to, and most knowledgeable about, the elements from which the Business Service Model is created.

Social networking applications have in recent years proliferated. Typically, a social network application facilitates construction of a social network of members connected by a common purpose. For example, members interested in developing a network of business contacts may participate in a network designed for that purpose. Very particular purposes may support a social network, such as travelers with layovers as described in U.S. Patent Publication No. 2009/0077061 to Abercrombie et al. A variety of applications have been developed to provide services to enhance the operation of such networks. For example, Internet based merchandisers may use social networking techniques to add value to shopping experiences by sharing product reviews with network friends as described in U.S. Patent Publication No. 2009/0070228 to Ronen.

Social networks may feature methods for determining social distance between members based on attributes provided by the members. These attributes may also be used to target advertising to members as described in U.S. Patent Publication No. 2009/0112701 to Turpin et al. or, in combination with social distance, may be used to present content to a member as described in U.S. Patent Publication No. 2009/0070700 to Johanson. Methodologies have been devised for one member of a social network to upload content, such as a picture, about another member, as described in U.S. Pat. No. 7,117,254 to Lunt et al.

There are also applications which use social network techniques to address problems that do not, in themselves, have anything to do with social networks. For example, U.S. Patent Publication No. 20090070168 to Thompson et al. describes a system for monitoring the use of electrical power by consumers, where information collected by various measuring devices is shared with a social network of experts. However, there are no prior art uses of social network techniques applied to the above described problems with creating and maintaining Business Service Models.

It is therefore an object of the present invention to provide a method for creating and maintaining a Business Service Model responsive to the complexity of the services, number of parties involved, and myriad of underlying technologies incorporated into the Business Service Model. The method of the invention is to apply a community and structured social networking paradigm to the task of managing the service. By distributing the task of initially establishing the Business Service Model, as well as maintaining this information as the services or its underlying components change, an organization can have a much more reliable, and current, Business Service Model available to use as the basis for monitoring, reporting, alerting, compliance, auditing, and business process management.

Building and maintaining currency of Business Service Models can be achieved only by providing IT staff, project managers, and other subject matter experts with a mechanism by which they establish and operate as groups of individuals who own responsibility for validating and maintaining the information contained in particular Business Service Models. Such groups are associated with “Communities” within the Configuration Management Database (CMDB) environment. Each of these Communities contains (i.e. has been assigned ownership responsibility for) one or more Business Service Models. This invention describes the process by which individuals associated with one or more such Communities can create and help maintain Business Service Models, relationships between elements of a Model, and rules governing data propagation within the Model. It should be noted that an element that is part of one Business Service Model can also be part of any number of other Business Service Models. Members of a Community (i.e. members of a group associated with a Community) can search for or browse Business Service Models contained within the Community and view, update, delete, tag, comment on, or generate reports on any aspect of these Business Service Models.

Administrators of the system construct Communities. Each Community contains Business Service Models and represents a group of individuals responsible for creating and maintaining the Business Service Models contained in the Community. The Communities also contain permissions which allow/disallow individuals from performing one or more sets of actions with respect to the Business Service Models and their components, including (but not limited to) read, create, modify, delete, update, tag, mark, and comment.

The method by which an initial set of Business Service Models can be built is dependent on the underlying implementation and may vary significantly for each deployment. For example, an initial service model could be constructed by combining an IT infrastructure discovery tool (a computer implemented software application) with an application dependency mapping solution (also a computer implemented software application). In a different scenario, information from an asset management system (also a computer implemented software application or set of software applications) could be combined with spreadsheets containing information about disaster recovery plans. Both of these would produce an initial set of Business Service Models on which the Community members could operate for the purposes of validation, refinement, additions, and completion.

A computer based environment for the initial set of Business Service Models enables individual users to view information about any given Business Service Model in a Community, including history of changes that have been made to it. In addition, an interface for the Models are so constructed (in accordance with principles well known in the computer software arts) that individuals can choose to add any missing relationships, elements, state propagation rules, or algorithms. Dated aspects of a Business Service Model can similarly be deleted. Should any incorrect information be discovered, users have the option of either updating the Business Service Model, or tagging the information for update by another member of the Community. Updates can either be automatically approved or go through an approval process prior to being committed into the system.

Members of the Community are given methods, implemented via suitable software display interfaces, by which they can view all Business Service Models and components within the designated Community that have been tagged. This allows all members of the Community to contribute their expertise towards improving the overall quality of the Business Service Model.

Community oriented workspaces are provided via a suitable software display interface to facilitate the process by which members of that Community can track activities taking place on contained Business Service Models, including highlighting recent updates, models requiring updates, updates requiring approvals, new components added, and components deleted. The Business Service Models can be configured by members of the community to display real-time reporting functions, such as with graphs and tables. Members of the community can also configure the Business Service Models to display a state, events, and condition based on the Business Service Model's relationship to real-time data feeds within the IT infrastructure. The members of the community can also alter the Business Service Model to change the rules that govern the state calculations, for the purposes of display and reporting. All these configuration changes are made available via the community workspace to all members of the community.

Individuals are also provided with workspaces to facilitate their interaction with multiple Communities that they might be members of. Activities taking place within each Community are summarized for each individual user via a computer software interface that displays an activity feed which indicates changes within the Community such as changes to the Business Service Model, comments made by other members, components of the Business Service Model that have been tagged, among others.

The implementation of the invention described herein provides a method and system for maintaining business service models of an enterprise, the computer being used for enabling assignment by an administrator of individuals to one or more communities and for enabling distribution by the administrator of the business service models to the communities, where the individuals in a community as a group are responsible for creating and maintaining the business service models distributed to the community. Each individual in a community has particular expertise within the enterprise with respect to one or more pieces of information in the business service models distributed to the community. Also, the computer is used to enable an individual in the community to view information about a business service model in the community, and to enable the individual to add or delete or otherwise update information about the business service model, where the information touches upon the particular expertise of the individual. Then a record of the business service model update is displayed to other individuals within the community containing the business service model

In another aspect, the computer also enables the individual to tag information about the business service model for review and update by another member of the community. Further, the computer enables review of the individual's addition or deletion of information about the business service model by other members of the community prior to committing the update into the business service model. The computer also provides workspaces to facilitate the work being done to maintain the Business Service Models. These workspaces may include a community workspace enabling community members to monitor updates being made to the business service model. The workspaces may also include an individual workspace enabling the individual to monitor and update each business service model in each community of which the individual is a member.

Another aspect of the invention is use of the computer to display an activity feed indicating changes to the community, including updates and comments by members of the community. Additionally, the business service models are configured by individuals for community consumption to display real-time reporting functions. The business service models are configured by individuals in the community to display in the community workspace a state, an event or a condition based on the business service model's relationship to real-time data feeds within the IT infrastructure. Further, the business service models may be altered by individuals in the community in order to change the rules that govern state calculations for display and reporting. Finally, the particular expertise of the individual may be measured by the individual's use of community and individual workspaces.

By distributing Business Service Models across Communities and providing computer implemented mechanisms by which members of the Community can search, view, and operate on Business Service Models and their components in a continually iterative model, IT organizations can realize the full value of having a complete, accurate, and current Business Service Model.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic of a sample IT environment with elements and groups of elements representing components of a Business Service Model (BSM).

FIGS. 2A and 2B together show how a social network foundation for maintaining BSMs is related to a social network foundation for maintaining CI data quality and relationships; FIG. 2A is a schematic diagram showing associations between individuals and communities, and between BSMs and communities, which form a foundation for operation of social network capabilities to maintain BSMs; FIG. 2B is a schematic diagram showing associations between individuals and communities, and between CIs and communities, and relationships between CIs, which form a foundation for operation of social network capabilities to maintain CI data quality and CI relationships.

### DETAILED DESCRIPTION OF A PREFERRED EMBODIMENT OF THE INVENTION

In a typical IT organization, one of the most challenging tasks is managing and tracking the relationships between a varied mix of infrastructure, applications, services, physical locations and logical structures (e.g. lines of business, clusters, etc.) and how they all come together to form a large part of a Business Service Model. In addition to this information, in order to build a complete Business Service Model, it needs to incorporate rules that govern propagation of information in the model as well as algorithms to account for state calculations involving details such as redundancy.

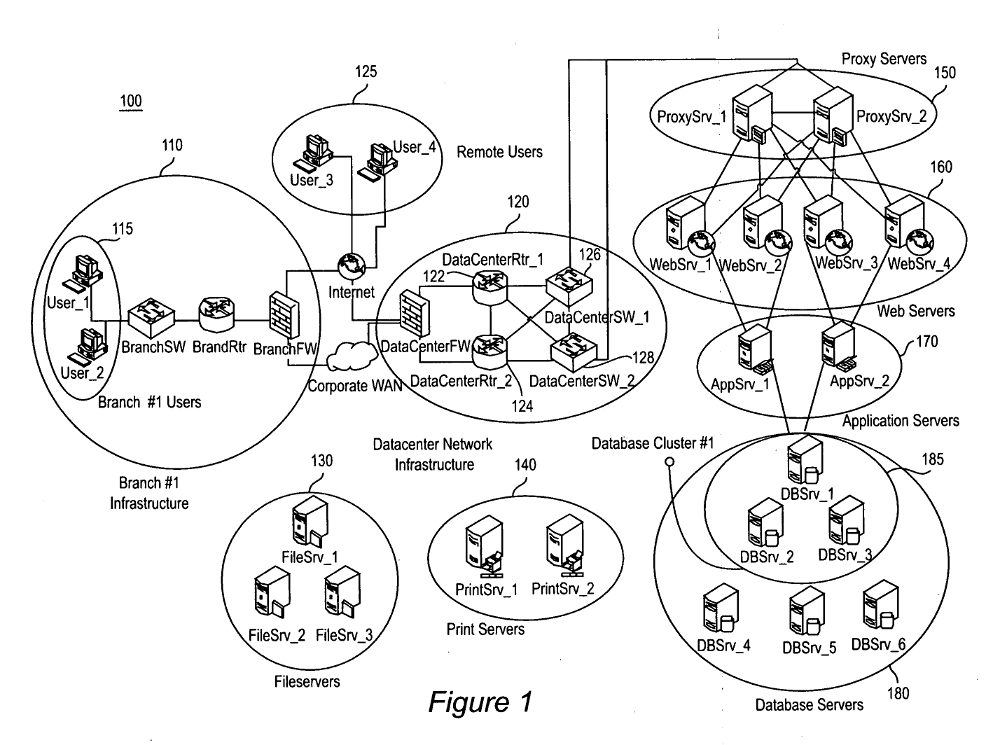

Referring now to the drawings, and more particularly to FIG. 1, there is shown a sample environment, a relationship map 100, which an IT organization is responsible for managing. A Business Service Model showing, for example, an Online Banking Service within this environment would include elements in the Datacenter Network Infrastructure 120, Proxy Servers 150, Web Servers 160, Application Servers 170, and Database Cluster #1 185 within Database Servers 180. In addition, aspects of availability and performance of the Internet 136 and Corporate WAN 135 3^{rd} party services would have to be incorporated into the service model.

The initial view that includes all the infrastructure elements (even those not in the Online Banking service, such as Fileservers 130, Print Servers 140, Branch #1 Infrastructure 110, including Branch #1 Users 115, and Remote Users 125) could be built using an asset management system, discovery tool, or monitoring solution. That information could in turn be overlaid with information from an application dependency mapping solution. Communities called “Online Banking” and “Support Systems” can be added to the system.

Individuals within Communities are provided with a computer implemented method by which they can construct and maintain these Business Service Models, each represented by a Community. For example, the Support Systems Community would build out a Business Service Model that includes just the File Servers 130 and Print Servers 140 but excludes all the other information. The Online Banking Community could build their service model ensuring that they exclude any irrelevant elements.

One of the most difficult challenges associated with relationship mapping is ensuring that the defined relationships are both complete and continue to stay up-to-date. In this example, the Online Banking Community would first have its members ensure that the raw information about elements and their relationships is correct. Following that, the Community members could focus in on incorporating rules that govern how the overall status of the business service is perceived. For example, they would have to build in rules that state that in the Datacenter Network Infrastructure 120 set of elements, any one of DataCenterRtr_1 122 or DataCenterRtr_2 124 could fail, but not both. Similar rules would be set up for the switches —DataCenterSW_1 126 or DataCenterSW_2 128. One failure would still mean that the service is functional but two failures would mean that it is not. In addition, algorithms would have to be put into place to determine how information would propagate from further downstream elements in the Business Service Model. An example of the latter would be deciding how a critical performance indicator from one of the Application Servers 170 would be reflected at the top of the business service. An example of this would be an individual user setting the state rule to indicate that a given cluster must have 30% of its servers operating in order to show an OK or Green state. This change to the service model would be displayed within the Community as a news feed, encouraging other members of the Community to comment or modify it. This information flow causes users to participate in the maintenance activities of the Business Service Model in a social sense.

To address this challenge, a computer implemented method is provided whereby a member of a Community can (based on assigned permissions) tag information as being incomplete, make changes to include any missing information in the Business Service Models, update models that others have tagged, or delete obsolete or incorrect models.

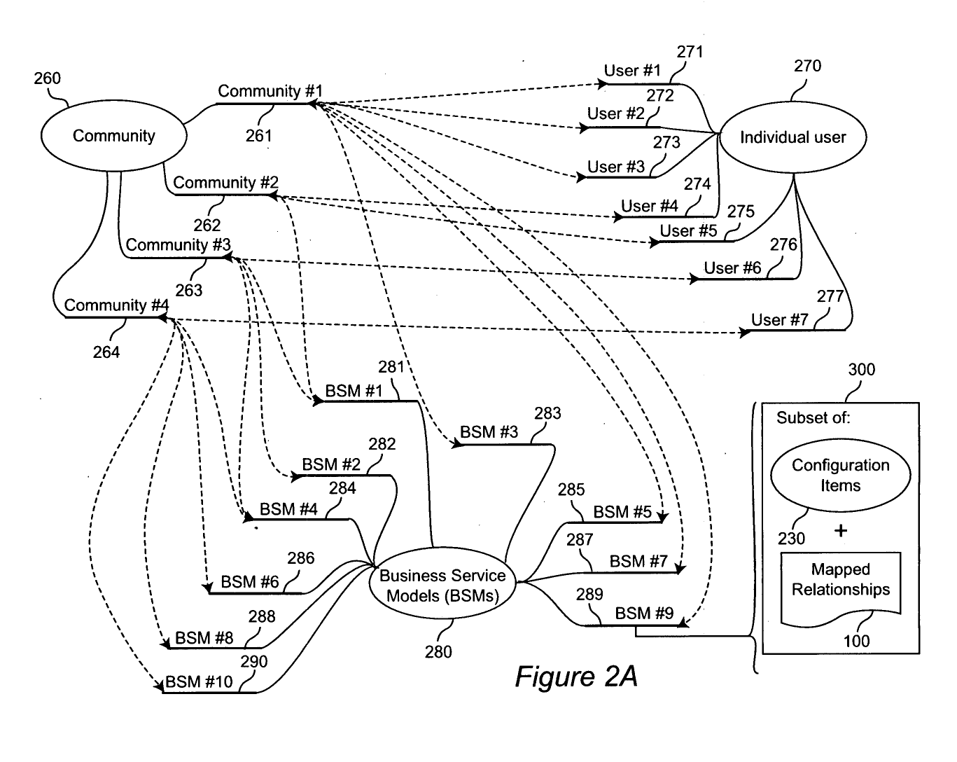

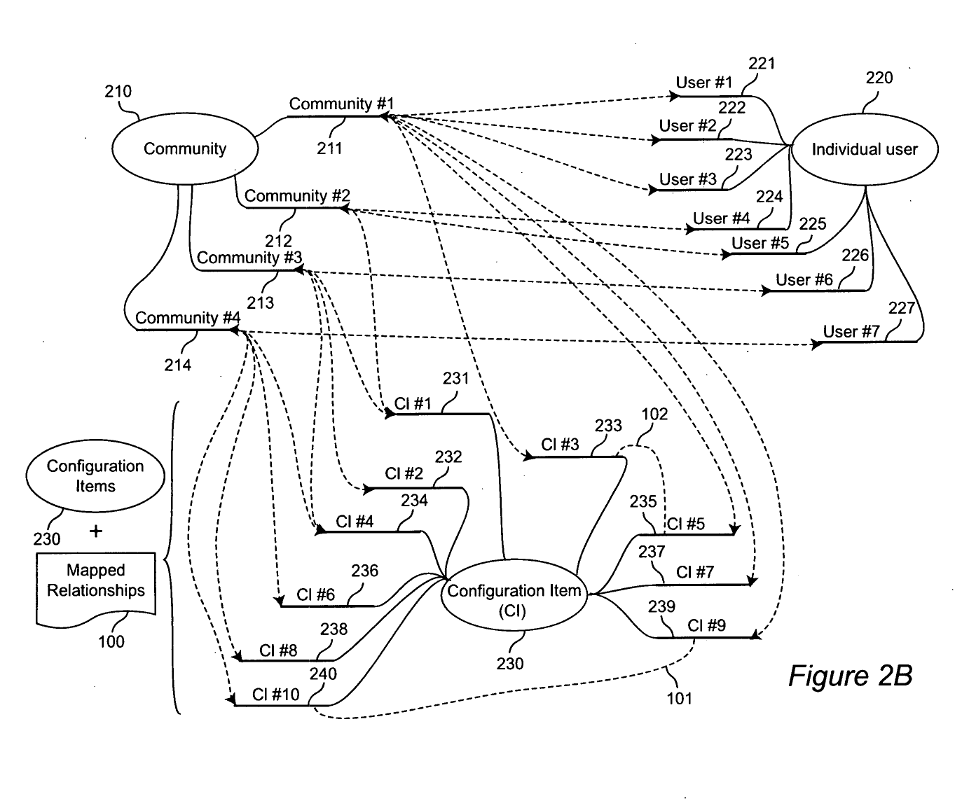

FIG. 2A describes the infrastructure provided by the computer implemented methods described in this invention for using social network techniques to maintain Business Service Models (BSMs). It illustrates the relationships between BSMs 280, Communities 260 and Users 270. A BSM 280 can belong to one or more communities 260 with a subset of its elements being maintained by each community. Business Service Models #3 283, #5 285, #7 287 and #9 289 belong to Community #1 261. Business Service Model #1 281 belongs to both Community #2 262 and Community #3 263. Business Service Model #2 282 belongs to Community #3 263, and Business Service Model #4 284 belongs to both Community #3 263 and Community #4 264. Business Service Models #6 286, #8 288 and #10 290 belong to Community #4 264.

Individual users 220 can be associated with one or more Communities and therefore with one or more BSMS. For example, as shown in FIG. 2A, three users (User #1 271, User #2 272 and User #3 273) are associated with Community #1 261. Users #4 274 and #5 275 are associated with Community #2 262. Users #6 276 and #7 277 are associated with Community #3 263 and Community #4 264, respectively.

These associations form the core of the social network upon which this invention builds. The logic of the invention is first to construct Business Service Models 280 from elements of the traditional CMDB structure. This is illustrated for BSM #9 289 which is built up from a subset 300 of Configuration Items 230 and Mapped Relationships 100. Using these components as building blocks (as illustrated above for “Online Banking”) the BSMs are structured to suit the needs of the respective particular models, having elements that may correspond to the building blocks or may be related to component building blocks in more aggregated or indirect ways (e.g. Database Cluster #1 185 for “Online Banking”). The BSMs 280 are then assigned to appropriate Communities 260; it may be appropriate to assign one BSM element to one Community and assign another BSM element to another Community. The invention is operable either way.

Similarly, FIG. 2B describes the parallel infrastructure for maintaining the details—configuration items and CI relationships—upon which the Business Service Models are built. It illustrates the relationships between CIs 230, Communities 210 and Users 220. A CI 230 can belong to one or more communities 210 with a subset of its attributes being maintained by each community. Configuration items #3 233, #5 235, #7 237 and #9 239 belong to Community #1 211. Configuration item #1 231 belongs to both Community #2 212 and Community #3 213. Configuration item #2 232 belongs to Community #3 213, and Configuration item #4 234 belongs to both Community #3 213 and Community #4 214. Configuration items #6 236, #8 238 and #10 240 belong to Community #4 214.

Individual users 220 can be associated with one or more Communities and therefore with one or more CIs. For example, as shown in FIG. 2B, three users (User #1 221, User #2 222 and User #3 223) are associated with Community #1 211. Users #4 224 and #5 225 are associated with Community #2 212. Users #6 226 and #7 227 are associated with Community #3 213 and Community #4 214, respectively.

The end goal of the community structure shown in FIG. 2B is to take the traditionally monolithic CMDB and separate it into Communities 210 where related CIs 230 and IT staff (individual users 220) with specialized knowledge pertaining to these CIs can be brought together for the purpose of validating and updating CI relationships. These relationships are shown in relationship map 100 in FIG. 1. The schematic form of FIG. 2B does not permit a comprehensive display of the relationships between and among CIs. However, exemplars of these mapped relationships 100 are indicated by the relationship 101 connecting CI 240 and CI 239, and the relationship 102 between CI 233 and CI 235. The mapped relationships 100 and configuration items 230 serve as the content of the CMDB.

The users 270 generally have responsibility for operational performance of business operations being modeled by the BSMs 280, and generally have corresponding specialized knowledge about the business operations being modeled. However, in contrast the underlying CIs and CI relationships, where the object of the social network process is accuracy and completeness of the CMDB, the object of a BSM is performance and responsiveness of the business operations being modeled. The expertise of the users relates to setting thresholds and balance points (e.g. in terms of percentages of equipment outages that can be tolerated without compromising service to customers) so that alerts are provided in time to avoid unacceptable performance. The social network and community techniques applied by the invention provide an improved methodology for leveraging the collective knowledge and skills of the community of users in a way that is superior to traditional lines of organization, responsibility and command.

As individual users are increasingly involved in the environment through the use of Community and Individual workspaces, this process is repeatedly applied to the Business Service Models. Each iteration incrementally adds new elements (or other information), corrects errors, and maintains existing elements. The end result is a Business Service Model definition for all IT services in the organization which better enable an IT organization to monitor, report on, alert, enable compliance reports, audit, and manage business processes.

While the invention has been described in terms of preferred embodiments, those skilled in the art will recognize that the invention can be practiced with modification within the spirit and scope of the appended claims.

1. A computer implemented method for maintaining business service models of an enterprise, the computer performing the steps of:
enabling assignment by an administrator of individuals to one or more communities;
enabling distribution by the administrator of said business service models to said communities, the individuals in a community as a group being responsible for creating and maintaining the business service models distributed to the community, each individual in a community having particular expertise within the enterprise with respect to one or more of the business service models distributed to the community or with respect to one or more elements of said business service models;
enabling an individual in the community to view information about a business service model in the community;
enabling the individual to add or delete or otherwise update information about the business service model, where the information touches upon the particular expertise of the individual; and
displaying a record of said business service model update to other individuals within the community containing the business service model.

2. A computer implemented method as in claim 1, the computer performing the further step of enabling the individual to tag information about the business service model for review and update by another member of the community.

3. A computer implemented-method as in claim 1, the computer performing the further step of enabling review of the individual's addition or deletion of information about the business service model by other members of the community prior to committing the update into the business service model.

4. A computer implemented method as in claim 1, the computer performing the further step of providing a community workspace enabling community members to monitor updates being made to the business service model.

5. A computer implemented method as in claim 1, the computer performing the further step of providing the individual with an individual workspace enabling the individual to monitor and update each business service model in each community of which the individual is a member.

6. A computer implemented method as in claim 4, the computer performing the further step of displaying an activity feed indicating changes to the community, including updates and comments by members of the community.

7. A computer implemented method as in claim 1, wherein the business service models are stored in a configuration management database.

8. A computer implemented method as in claim 4, wherein the business service models are configured by individuals for community consumption to display real-time reporting functions.

9. A computer implemented method as in claim 4, wherein the business service models are configured by individuals in the community to display in the community workspace a state, an event or a condition based on the business service model's relationship to real-time data feeds within the IT infrastructure.

10. A computer implemented method as in claim 9, wherein the business service models are altered by individuals in the community to change the rules that govern state calculations for display and reporting.

11. A computer implemented method as in claim 1, wherein the particular expertise of the individual is measured by the individual's use of community and individual workspaces.

12. A system for maintaining business service models representing IT configuration of an enterprise, comprising:
means implemented by a computer supporting a configuration management database of configuration items whose configuration is modeled by the business service models, said means enabling assignment by an administrator of individuals to one or more communities;
means implemented by the computer for enabling distribution by the administrator of said business service models to said communities, the individuals in a community as a group being responsible for creating and maintaining the business service models distributed to the community, each individual in a community having particular expertise within the enterprise with respect to one or more pieces of information in the business service models distributed to the community;
means implemented by the computer for enabling an individual in the community to view information about a business service model in the community;
means implemented by the computer for enabling the individual to add or delete or otherwise update information about the business service model, where the information touches upon the particular expertise of the individual; and
means implemented by the computer for displaying a record of said business service model update to other individuals within the community containing the business service model.

13. A system for maintaining business service models representing IT configuration of an enterprise as in claim 12, further comprising means implemented by the computer for enabling the individual to tag information about the business service model for review and update by another member of the community.

14. A system for maintaining business service models representing IT configuration of an enterprise as in claim 12, further comprising means implemented by the computer for enabling review of the individual's addition or deletion of information about the business service model by other members of the community prior to committing the update into the business service model.

15. A system for maintaining business service models representing IT configuration of an enterprise as in claim 12, further comprising means implemented by the computer for providing a community workspace enabling community members to monitor updates being made to the business service model.

16. A system for maintaining business service models representing IT configuration of an enterprise as in claim 12, further comprising means implemented by the computer for providing the individual with an individual workspace enabling the individual to monitor and update each business service model in each community of which the individual is a member.

17. A system for maintaining business service models representing IT configuration of an enterprise as in claim 15, further comprising means implemented by the computer for displaying an activity feed indicating changes to the community, including updates and comments by members of the community.

18. A computer implemented system for maintaining business service models representing IT configuration of an enterprise, the computer system having software modules stored thereon and having a processor operable to execute the software modules, the software modules comprising:
first computer code for enabling assignment by an administrator of individuals to one or more communities;
second computer code for enabling distribution by the administrator of said business service models to said communities, the individuals in a community as a group being responsible for creating and maintaining the business service models distributed to the community, each individual in a community having particular expertise within the enterprise with respect to one or more pieces of information in the business service models distributed to the community;
third computer code for enabling an individual in the community to view information about a business service model in the community;
fourth computer code for enabling the individual to add or delete or otherwise update information about the business service model, where the information touches upon the particular expertise of the individual; and
fifth computer code for displaying a record of said business service model update to other individuals within the community containing the business service model.

19. A computer implemented system for maintaining business service models representing IT configuration of an enterprise as in claim 18, further comprising sixth computer code for providing a community workspace enabling community members to monitor updates being made to the business service model.

20. A computer implemented system for maintaining business service models representing IT configuration of an enterprise as in claim 19,
wherein the business service models are configured by individuals for community consumption to display real-time reporting functions;
wherein the business service models are configured by individuals in the community to display in the community workspace a state, an event or a condition based on the business service model's relationship to real-time data feeds within the IT infrastructure; and
wherein the business service models are altered by individuals in the community to change the rules that govern state calculations for display and reporting.
